(19) United States
(12) Patent Application Publication
(10) Pub. No.: US 2006/0140674 A1
(43) Pub. Date: Jun. 29, 2006

(54) Image-forming apparatus

(75) Inventor: Shougo Sato, Seto-shi (JP)

Correspondence Address: BANNER & WITCOFF, LTD.;ATTORNEYS FOR CLIENT NOS. 0166889, 006760, 1001 G STREET, N.W., 11TH FLOOR, WASHINGTON, DC, 20001-4597, US

(73) Assignee: Brother Kogyo Kabushiki Kaisha, Nagoya-shi (JP)

(21) Appl. No.: 11/316,951

(22) Filed: Dec. 27, 2005

(30) Foreign Application Priority Data
Dec. 27, 2004 (JP) 2004-378082

(51) Int. Cl. G03G 15/08

(52) U.S. Cl. 399/119

(57) ABSTRACT

An image-forming apparatus includes: a main body; at least one photosensitive member; an exposing unit; a plurality of developing units; a transferring unit; and a first holding unit. The photosensitive member has an axis. The first holding unit holds the plurality of developing units that are arranged in a row along a first removal direction that is orthogonal to the axis of the photosensitive member and that is substantially horizontal. The first holding unit is accommodated at a first accommodating position in the main body and is capable of being moved, independently from the photosensitive member, to a first removal position that is separate from the first accommodating position in the first removal direction.

### CROSS REFERENCE TO RELATED APPLICATIONS

This application claims priority from Japanese Patent Application No. 2004-378082 filed Dec. 27, 2004. The entire content of the priority application is incorporated herein by reference.

### TECHNICAL FIELD

The disclosure relates to an image-forming apparatus for developing electrostatic latent images formed on a photosensitive member to form images on a recording medium.

### BACKGROUND

One type of image-forming apparatus well known in the art includes various components that are capable of being removed from the image-forming apparatus by sliding the components horizontally. In one of these image-forming apparatuses disclosed in Japanese unexamined patent application publication No. HEI-5-257340, the entire image-forming unit provided in the image-forming apparatus can be pulled outward by sliding the unit, in order to exchange developer cartridges accommodated therein.

In another image-forming apparatus disclosed in Japanese unexamined patent application publication No. 2001-272899, image forming units, which include rollers such as photosensitive drums, can be pulled outward along the axial direction of the rollers.

### SUMMARY

By enabling the components to be pulled horizontally in the image-forming apparatuses described above, less force is required to remove the components than when the components are removed directly upward. However, since the image-forming unit being slid in the image-forming apparatus disclosed in Japanese unexamined patent application publication No. HEI-5-257340, is heavy, the image-forming apparatus becomes susceptible to falling over when sliding the image-forming unit.

Further, since the rollers provided in the image-forming unit of the image-forming apparatus according to Japanese unexamined patent application publication No. 2001-272899 are pulled in the axial direction thereof, the rollers need only be pulled a distance approximately equivalent to the width of the recording medium. Accordingly, this image-forming apparatus requires less distance for removing the rollers than the image-forming apparatus disclosed in Japanese unexamined patent application publication No. HEI-5-257340, and avoids the risk of tipping over the image-forming apparatus. However, large openings are required in the frame of the image-forming apparatus for removing the several rollers, making it difficult to maintain the rigidity of the image-forming apparatus.

Further, in order to remove the rollers from the image-forming apparatus, it is necessary to have members, such as bearings used for holding and positioning the rollers, recede from the rollers. It becomes difficult to ensure accuracy for positioning the rollers.

Additionally, a large hole is formed in one side wall of the frame that is located on the side of one longitudinal end of the shaft of each roller. Accordingly, the shaft of each roller is supported only at its other longitudinal end by the other side wall of the frame. It is therefore difficult to maintain the accurate position of each roller.

In view of the foregoing, it is an object of the invention to provide an image-forming apparatus for forming images using developer that has enhanced stiffness and that is less likely to fall over when removing components from the device.

In order to attain the above and other objects, the invention provides an image-forming apparatus, including: a main body; at least one photosensitive member; an exposing unit; a plurality of developing units; a transferring unit; and a first holding unit. The photosensitive member has an axis. The exposing unit forms electrostatic latent images on the surface of the photosensitive member. Each developing unit has a developer-accommodating section that accommodates developer and a developer-carrying member that develops a corresponding electrostatic latent image formed by the exposing unit on the photosensitive member into a visible image by supplying developer from the developer-accommodating section onto the surface of the photosensitive member. The transferring unit transfers the visible images formed on the photosensitive member to a recording medium. The first holding unit holds the plurality of developing units that are arranged in a row along a first removal direction that is orthogonal to the axis of the photosensitive member and that is substantially horizontal. The first holding unit is accommodated at a first accommodating position in the main body and is capable of being moved, independently from the photosensitive member, to a first removal position that is separate from the first accommodating position in the first removal direction.

### BRIEF DESCRIPTION OF THE DRAWINGS

Illustrative aspects in accordance with the invention will be described in detail with reference to the following figures wherein:

FIG. 1 is a side cross-sectional view of a printer according to an illustrative aspect of the invention;

FIG. 2 is a side cross-sectional view of the printer when a door is open;

FIG. 3 is a side cross-sectional view of the printer showing the developing unit being pulled out;

FIG. 4 is a side cross-sectional view of the printer showing a photosensitive drum unit being pulled out after the developing unit has been removed;

FIG. 5(a) is a side cross-sectional view of the printer showing the photosensitive drum unit being removed while the developing unit is still mounted;

FIG. 5(b) is a cross-sectional view illustrating the photosensitive drum unit mounted in a photosensitive-drum-unit guide mechanism in the main body of the printer;

FIG. 5(c) is a side view of a right-side guide wall in the photosensitive-drum-unit guide mechanism seen from the left side thereof and illustrating male coupling members provided on the right-side guide wall;

FIG. 5(d) is a side view of a right-side wall of a frame in the photosensitive drum unit seen from the inner (left) side thereof and illustrating female coupling members and intermediate gears provided on the inner (left) side of the right-side wall; and

FIG. 6 is a side cross-sectional view showing a variation of the printer (multifunction device) according to the above-described aspect.

### DETAILED DESCRIPTION

An image-forming apparatus according to some aspects of the invention will be described while referring to the accompanying drawings wherein like parts and components are designated by the same reference numerals to avoid duplicating description.

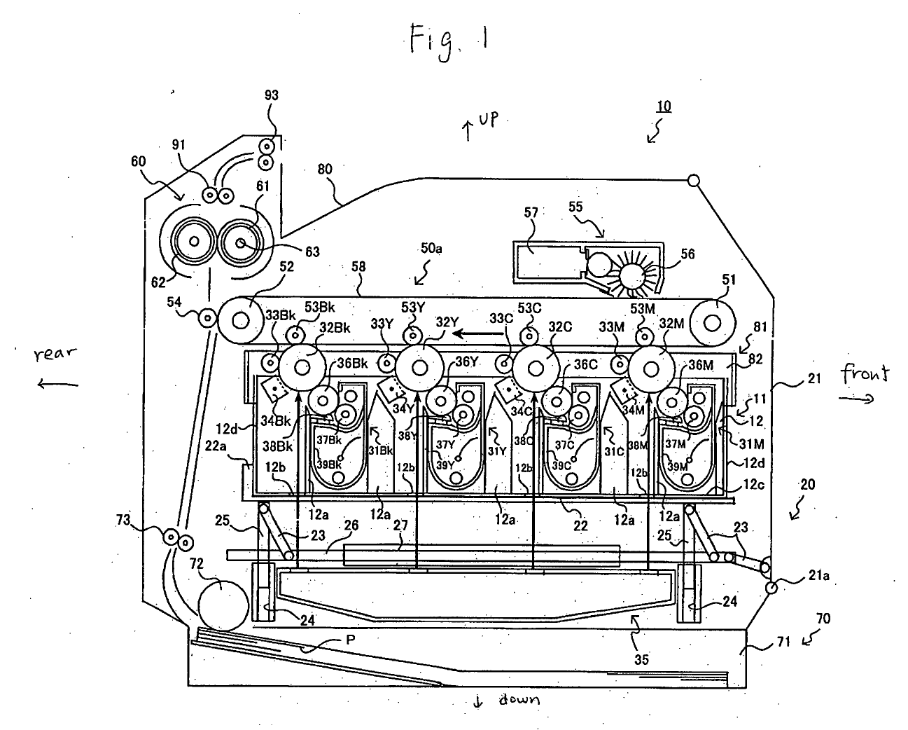

FIG. 1 is a side cross-sectional view of a printer 10 according to some aspect of the invention. As shown in FIG. 1, the printer 10 is a tandem color laser printer that includes a developing unit 11, a photosensitive drum unit 81, a lifting mechanism 20 for raising the developing unit 11, a transfer unit 50a, a fixing unit 60, a feeding unit 70, a discharge tray 80, and an exposing device 35.

In the following description, the expressions “front”, “rear”, “upper”, “lower”, “right”, and “left” are used to define the various parts when the printer 10 is disposed in an orientation in which it is intended to be used. In this example, the side of the printer 10 on which a door 21 (to be described later) is provided will be referred to as the “front side” hereinafter. The right-to-left direction will be referred to also as the “widthwise direction” hereinafter.

Next, each of these components will be described in greater detail. First the developing unit 11 will be described.

The developing unit 11 includes a tray 12 functioning as a holder; and developer cartridges 31M, 31C, 31Y, and 31Bk for forming visible images with toner in each of the colors magenta (M), cyan (C), yellow (Y), and black (Bk), respectively. Hereinafter, components having reference numerals with letters appended to signify the color (e.g., M, C, Y, and Bk) will be collectively or generically referred to by the reference numeral alone (e.g., developer cartridges 31 or developer cartridge 31) unless referring to a specific color.

Each developer cartridge 31 includes a developer case 39 (39M, 39C, 39Y, and 39Bk) functioning as an outer casing of the developer cartridge 31 and accommodating toner therein.

Developing rollers 36 (36M, 36C, 36Y, and 36Bk) are provided in the respective developer cartridges 31 mounted in the developing unit 11. Each developing roller 36 is formed in a cylindrical shape with an electrically conductive silicone rubber as the base material, the surface of which is coated with a resin or a rubber material containing fluorine. However, the developing roller 36 need not be configured of a conductive silicone rubber as the base material, but may instead be configured of a conductive urethane rubber, for example. The average roughness (Rz) at ten points on the surface of the developing rollers 36 is set to 3-5 μm that is smaller than the average particle size of toner, which is 9 μm.

The developer cartridges 31 are also provided with supply rollers 37 (37M, 37C, 37Y, and 37Bk). Each supply roller 37 is formed of a conductive sponge roller and is configured to contact the respective developing roller 36 with pressure applied by the elastic force of the sponge. The supply roller 37 can be configured of an appropriate foam member formed of a conductive silicone rubber, EPDM, urethane rubber, or the like.

Each developer cartridge 31 also includes a thickness-regulating blade 38 (38M, 38C, 38Y, and 38Bk). The thickness-regulating blade 38 includes a base part that is plate-shaped and formed of stainless steel or the like and is fixed to a wall of the respective developer case 39, and a free end formed of an insulating silicone rubber or an insulating rubber or synthetic resin containing fluorine. The free end of each thickness-regulating blade 38 contacts the respective developing roller 36 from the lower side with pressure.

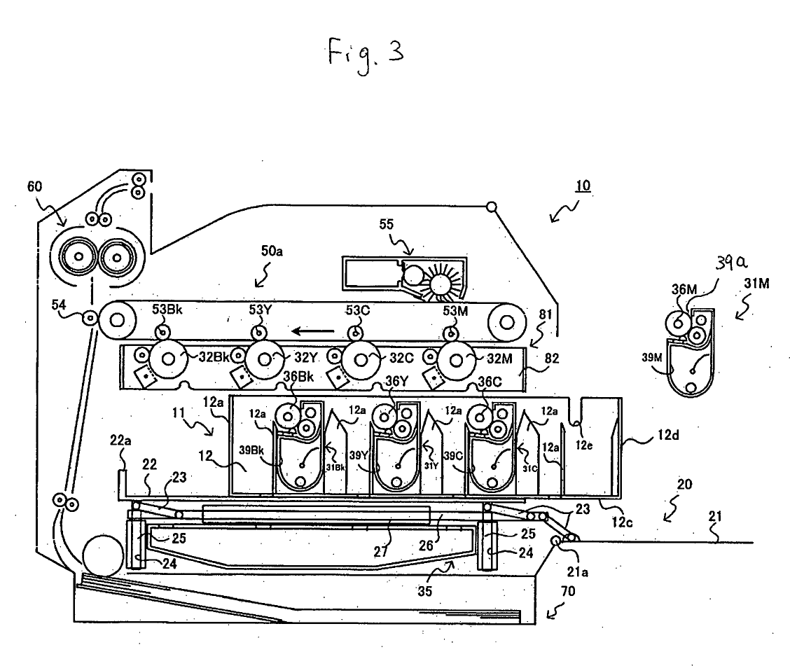

The developing rollers 36 described above are each provided above the respective developer case 39. Each developer case 39 has an opening 39a (FIG. 3) near the top through which toner is supplied externally to the developing roller 36.

The tray 12 is configured of a bottom wall 12c that is rectangular in shape, side walls 12d erected from peripheral edges of the bottom wall 12c, and a plurality of partitioning plates 12a dividing the internal space formed by the bottom wall 12c and side walls 12d.

Slits 12b are formed in the bottom wall 12c for each of the developer cartridges 31 so as not to block the paths of laser beams emitted from the exposing device 35 toward the photosensitive drum unit 81. The slits 12b are formed for each of the developer cartridges 31 at positions separated from the partitioning plates 12a. Components constituting the photosensitive drum unit 81 (specifically, photosensitive drums 32, chargers 34, and the like described later) are positioned above the respective slits 12b. This construction decreases the likelihood of toner falling through the slits 12b, thereby preventing toner from contaminating the interior of the printer 10 below the tray 12.

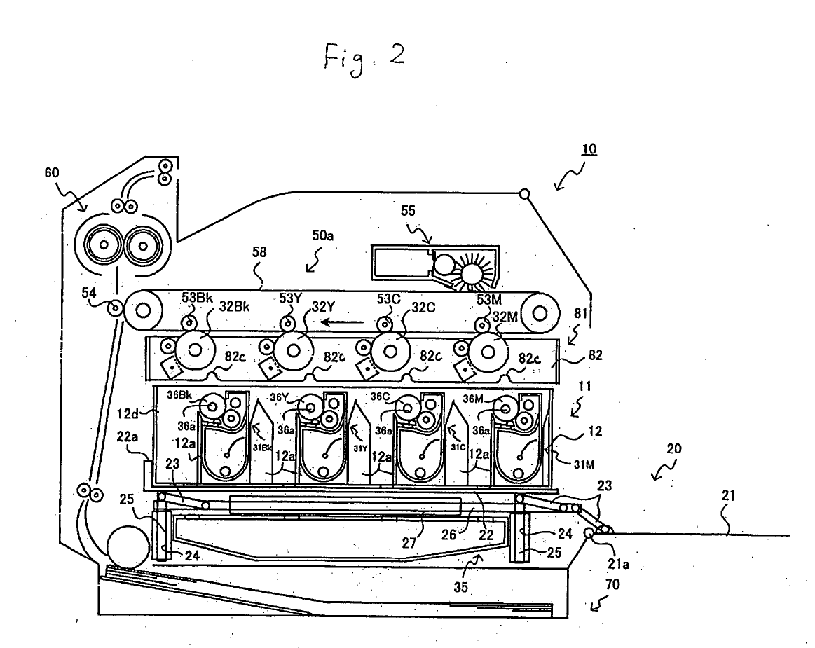

A U-shaped cutout part 12e (see FIG. 3) is formed in the side walls 12d for each of the developer cartridges 31. The developing rollers 36 are rotatably supported in the respective cutout parts 12e via support shafts 36a (see FIG. 2).

The developer cartridges 31 are mounted in the tray 12 by engaging the support shafts 36a of the developing rollers 36 in the respective cutout parts 12e and by bringing the periphery of the developer cartridges 31 into contact with the side walls 12d and the partitioning plates 12a. Thus, the developer cartridges 31 can be properly positioned in the tray 12, with the support shafts 36a extending horizontally in the widthwise (right-to-left) direction.

Next, the photosensitive drum unit 81 will be described in greater detail. The photosensitive drum unit 81 includes a frame 82 having a square or rectangular tube shape. Within the frame 82, the photosensitive drum unit 81 includes photosensitive drums 32 (32M, 32C, 32Y, and 32Bk), cleaning rollers 33 (33M, 33C, 33Y, and 33Bk), and chargers 34 (34M, 34C, 34Y, and 34Bk) Inverted U-shaped cutout parts 82c (see FIG. 2) are formed in the frame 82 corresponding to each of the developer cartridges 31. The cutout parts 82c can engage with the support shafts 36a of the developing rollers 36.

Each photosensitive drum 32 (organic photoconductors) mounted in the photosensitive drum unit 81 is formed, for example, of an aluminum hollow tube covered by a photosensitive layer with a positive charging nature. The photosensitive layer is formed at a thickness of 20 μm or greater. Further, the aluminum hollow tube is used as a grounding layer.

The cleaning rollers 33 are resilient rollers formed of an electrically conductive sponge or the like and are disposed in sliding contact with the lower sections of the photosensitive drums 32. Since the printer 10 employs a cleanerless developing method, residual toner that the cleaning rollers 33 remove from the photosensitive drums 32 is once again returned to the photosensitive drums 32 within a prescribed cycle after the developing process has been completed. The toner is then recovered by the developing rollers 36 and returned to the developer cartridges 31.

The chargers 34 are Scorotron-type charging devices. The chargers 34 confront, but do not contact, the surfaces of the respective photosensitive drums 32 from the bottom side thereof at a position downstream of the respective cleaning rollers 33 in the rotational direction of the photosensitive drums 32.

The exposing device 35 is configured of a laser scanning unit well known in the art. The exposing device 35 is disposed below and separated a prescribed distance from the developing unit 11, vertically overlapping the photosensitive drums 32 and chargers 34. The exposing device 35 irradiates laser beams on the surfaces of the photosensitive drums 32 at a position downstream of the chargers 34 in the rotational direction of the photosensitive drums 32. The exposing device 35 irradiates laser beams onto the surfaces of the photosensitive drums 32 based on image data in order to form electrostatic latent images for each color on the surfaces of the photosensitive drums 32.

When disposed below the developing unit 11 in this way, the exposing device 35 is less likely to be influenced by vibrations than when disposed in the top of the device.

With this construction, the supply rollers 37 supply positively charged toner to the respective developing rollers 36, and the respective thickness-regulating blades 38 maintain the toner carried on the developing rollers 36 at a uniform thin layer. Subsequently, positively charged electrostatic latent images formed on the photosensitive drums 32 can be developed with the positively charged toner according to the reverse developing method at the point of contact between the developing rollers 36 and the respective photosensitive drums 32, thereby forming an image of very high quality.

Next, the transfer unit 50a will be described in greater detail. The transfer unit 50a includes an intermediate transfer belt 58, drive rollers 51 and 52 about which the intermediate transfer belt 58 is looped and supported, and intermediate transfer rollers 53 (53M, 53C, 53Y, and 53Bk).

The intermediate transfer belt 58 is a conductive sheet manufactured of polycarbonate, polyimide, or the like and formed in a belt shape. The intermediate transfer belt 58 travels circularly in contact with each of the photosensitive drums 32. The intermediate transfer rollers 53 are disposed within the loop of the intermediate transfer belt 58 at positions opposing the respective photosensitive drums 32.

The intermediate transfer belt 58 is disposed such that the surface opposing the photosensitive drums 32 moves in a horizontal direction from the magenta developer cartridge 31M toward the black developer cartridge 31Bk.

A prescribed voltage is applied to the intermediate transfer rollers 53 in order to temporarily transfer a toner image formed on each of the photosensitive drums 32 onto the intermediate transfer belt 58. A secondary transfer roller 54 is disposed at a position in which the toner image is transferred onto a paper P, that is, opposite the drive roller 52, downstream of the photosensitive drums 32 with respect to the moving direction of the intermediate transfer belt 58 and on the surface of the intermediate transfer belt 58 that opposes the photosensitive drums 32. A prescribed potential is applied to the secondary transfer roller 54. As a result, a four-color toner image carried on the intermediate transfer belt 58 is transferred onto the paper P.

A cleaning unit 55 is disposed on the opposite side of the intermediate transfer belt 58 from the photosensitive drums 32. The cleaning unit 55 includes a scraping member 56, and a case 57. Toner remaining on the intermediate transfer belt 58 after the transfer operation is scraped off by the scraping member 56 and collected in the case 57.

Next, the fixing unit 60 will be described in greater detail. The fixing unit 60 includes a heating roller 61 and a pressure roller 62 that rotate in contact with each other. A heater 63 such as a halogen lamp is provided inside the heating roller 61 for emitting heat when electrified to raise the temperature of the heating roller 61. After a toner image has been transferred onto the paper P, the toner image is fixed to the paper P by heat and pressure as the paper P is pinched between and conveyed by the heating roller 61, heated to a fixing temperature of about 180° C. during the printing operation, and the pressure roller 62 that applies pressure to the heating roller 61.

The fixing unit 60 is not disposed on either the tray 12 or the photosensitive drum unit 81, but in the top section of the printer 10. Accordingly, the fixing unit 60 is not affected by movement of the tray 12 or photosensitive drum unit 81.

Next, the feeding unit 70 will be described in greater detail. The feeding unit 70 is disposed in the bottommost section of the printer 10 and includes a loading tray 71 for accommodating the paper P, and a pickup roller 72 for feeding the paper P. The feeding unit 70 is configured to feed the paper P at a prescribed timing in relation to an image-forming process performed by the exposing device 35, developer cartridges 31, photosensitive drums 32, and intermediate transfer belt 58. A pair of conveying rollers 73 disposed downstream of the pickup roller 72 in the feeding direction receive the paper P fed by the feeding unit 70 and convey the paper P to the point of contact (nip point) between the intermediate transfer belt 58 and the secondary transfer roller 54.

The discharge tray 80 is disposed on the discharge side of the fixing unit 60 for accommodating discharged sheets of paper P. Pairs of conveying rollers 91 and 93 disposed downstream of the fixing unit 60 receive the paper P and discharge the paper P onto the discharge tray 80.

Next, the lifting mechanism 20 will be described in greater detail. The lifting mechanism 20 includes a rotational shaft 21a, a door 21 that swings open and closed about the rotational shaft 21a, a support base 22 for supporting the developing unit 11, a plurality of lifting members 25 fixed directly beneath the support base 22, a plurality of lifting support members 24 that slidably support the lifting members 25, a horizontal moving member 26, a horizontal movement support member 27 for slidably supporting the horizontal moving member 26 in the horizontal direction, and linking members 23 connecting the door 21 to the horizontal moving member 26 and the horizontal moving member 26 to the lifting members 25.

An end wall 22a is provided on an end of the support base 22 (hereinafter referred to as the “rear end”) opposite the end on which the door 21 is provided (hereinafter referred to as the “front end”). When the developing unit 11 is resting on the support base 22 in contact with the end wall 22a and the door 21 is rotated open or closed, the support base 22 is lifted or lowered, thereby allowing the developing unit 11 (the developing rollers 36) to be mounted on or detached from the photosensitive drums 32. The operations of the lifting mechanism 20 will be described in greater detail later.

Next, the operations of the printer 10 will be described in detail. First, the chargers 34 apply a uniform charge to the photosensitive layers on the surfaces of the respective photosensitive drums 32 as the photosensitive drums 32 are driven to rotate. Next, these photosensitive layers are exposed to the exposing device 35 based on image data for each of the colors magenta, cyan, yellow, and black. The developer cartridges 31 develop the latent images formed on the photosensitive surfaces of the respective photosensitive drums 32 in the colors magenta, cyan, yellow, and black, respectively, by depositing magenta toner, cyan toner, yellow toner, and black toner on the respective latent images. The toner images in magenta, cyan, yellow, and black formed on the photosensitive drums 32 in this way are temporarily transferred onto the surface of the intermediate transfer belt 58. The toner image for each color is formed at slightly different times with consideration for the velocity of the intermediate transfer belt 58 and the positions of the photosensitive drums 32 in order to transfer the toner images so that the toner images in each color are superimposed on the intermediate transfer belt 58. Any toner remaining on the photosensitive drums 32 after the transfer is temporarily retained by the respective cleaning rollers 33.

The four-color toner image formed on the intermediate transfer belt 58 as described above is transferred to the paper P fed from the feeding unit 70 at the nip point between the secondary transfer roller 54 and intermediate transfer belt 58. After the toner image is fixed to the paper P in the fixing unit 60, the paper P is discharged onto the discharge tray 80, thereby completing the formation of a four-color image.

Next, the operations of the lifting mechanism 20 will be described with reference to FIGS. 1 and 2.

When the door 21 is closed, as shown in FIG. 1, the support base 22 is raised upward. In other words, the horizontal moving member 26 is moved to the rear side, and the lifting members 25 are moved vertically upward by the linking members 23 connecting the lifting members 25 to the horizontal moving member 26. Accordingly, the support base 22 is also moved vertically upward.

In this state, that is, when the support base 22 is pushed upward, the support shafts 36a of the developing rollers 36 are engaged in the cutout parts 82c (see FIG. 2) formed in the frame 82. Hence, the developing unit 11 and the photosensitive drum unit 81 are positioned relative to each other. The position of the developing unit 11 at this time shown in FIG. 1 will be referred to as the “first accommodating position” hereinafter.

From this state, when the door 21 is opened as shown in FIG. 2, the support base 22 is pulled downward near the exposing device 35.

More specifically, the linking members 23 that move when the door 21 opens pull the horizontal moving member 26, moving the horizontal moving member 26 from the rear side toward the front side. By moving the horizontal moving member 26 to the front side, the lifting members 25 are moved vertically downward by the linking members 23.

As the developing unit 11 moves vertically downward along with the support base 22, the support shafts 36a of the developing rollers 36 disengage from the cutout parts 82c formed in the frame 82, enabling the developing unit 11 to be moved freely over the top surface of the support base 22. The position of the developing unit 11 at this time shown in FIG. 2 will be referred to as the “standby position” hereinafter. As a result, the developing unit 11 can be pulled in a substantially horizontal direction (forward direction) that is orthogonal to support shafts 32a to be described later, at which the photosensitive drums 32 are supported on the frames 82.

Next, the operation for removing the developing unit 11 and the photosensitive drum unit 81 will be described with reference to FIGS. 3 through 5(c).

As shown in FIG. 3, the developing unit 11 can be pulled part way from the body of the printer 10 so that only the magenta developer cartridge 31M or another developer cartridge 31 can be removed from the developing unit 11.

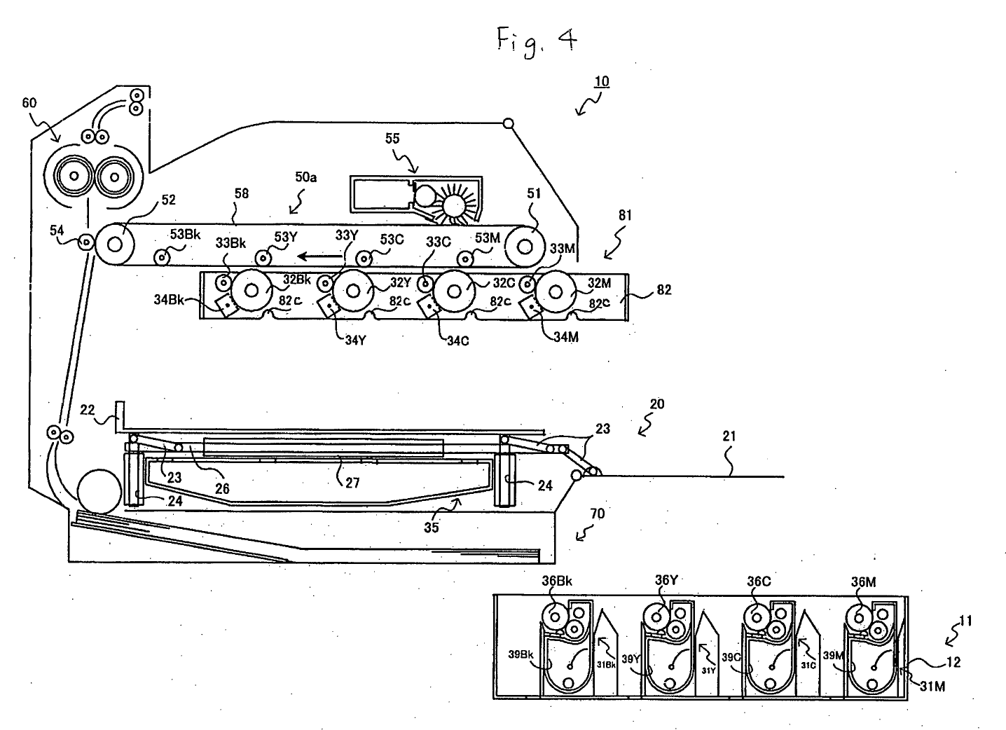

By continuing to pull the developing unit 11, the developing unit 11 can be entirely removed from the body of the printer 10, as shown in FIG. 4. The position of the developing unit 11 shown in FIG. 3 just before the developing unit 11 is pulled out completely from the printer 10 will be referred to as the “first removal position”.

Even when the developing unit 11 is pulled out completely from the printer 10, the developer cartridges 31 still remain mounted in the developing unit 11 on the bottom wall 12 of the tray 12. Accordingly, the developing unit 11 can be placed nearly anywhere, including on a sloped or irregular surface.

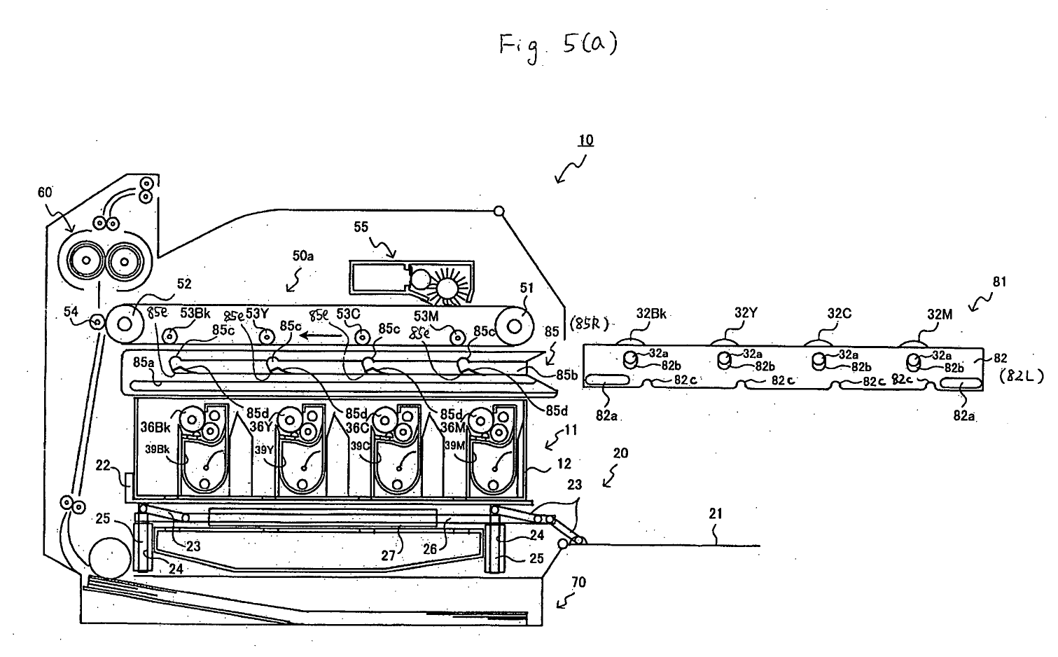

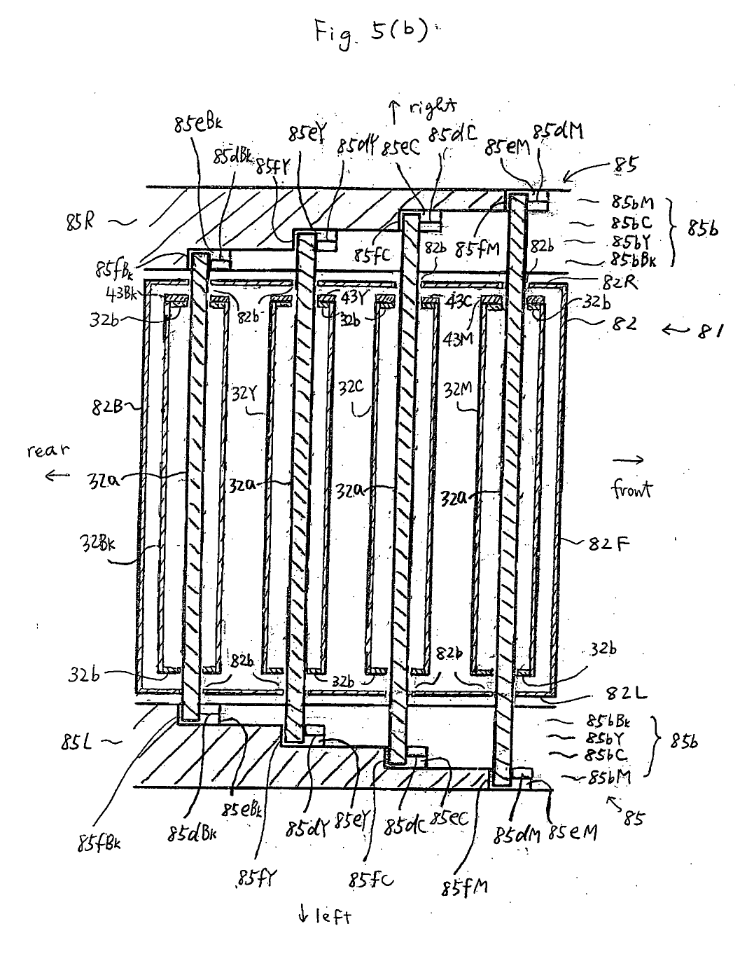

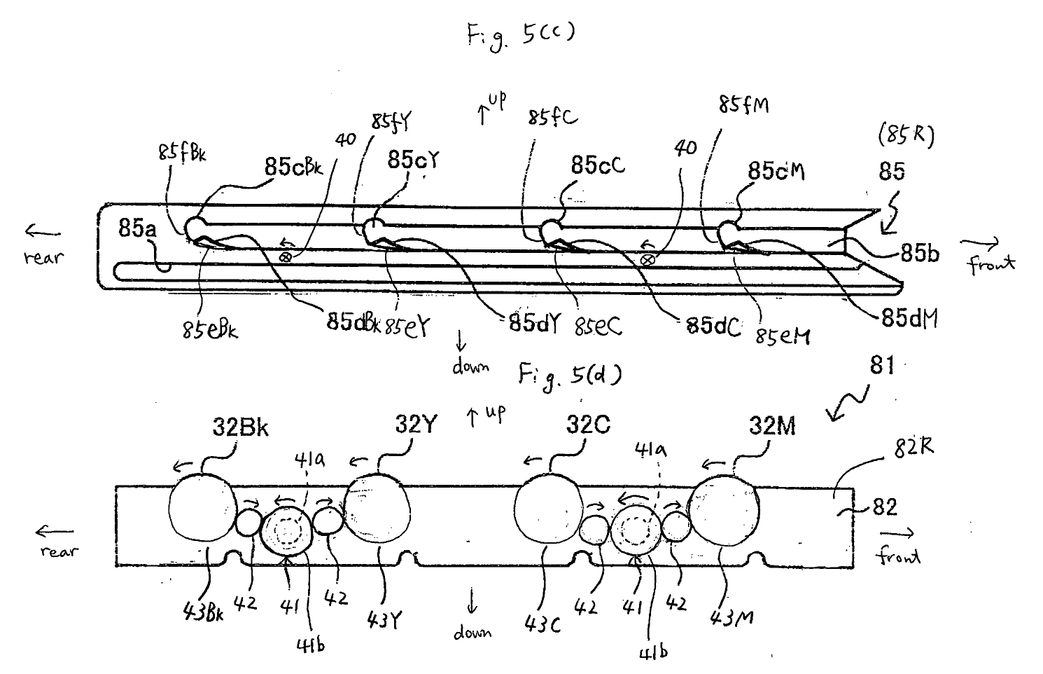

As shown in FIG. 4 and FIG. 5(a), the photosensitive drum unit 81 can be pulled and removed from the body of the printer 10 in the same direction (removal direction or forward direction) in which the developing unit 11 is removed from the printer 10, after the developing unit 11 has been removed. The position of the photosensitive drum unit 81 shown in FIG. 1 when the photosensitive drum unit 81 is mounted in the printer 10 will be referred to as the “second accommodating position”. The position of the photosensitive drum unit 81 shown in FIG. 4 just before the photosensitive drum unit 81 is pulled out completely from the printer 10 will be referred to as the “second removal position”.

As shown in FIG. 5(a), the photosensitive drum unit 81 can be removed without first removing the developing unit 11. To accomplish this, a photosensitive-drum-unit guide mechanism 85 is provided in the body of the printer 10 for detachably fixing the photosensitive drum unit 81. Protruding parts are provided on the photosensitive drum unit 81 for engaging with the photosensitive-drum-unit guide mechanism 85.

More specifically, a plurality of protruding parts 82a is formed on the frame 82 of the photosensitive drum unit 81. The protruding parts 82a are elongated along the horizontal. Insertion through-holes 82b are also formed in the frame 82 corresponding to each of the photosensitive drums 32. The photosensitive drums 32 each have a support shaft 32a that inserts into the respective insertion through-holes 82b. When inserted into the insertion through-holes 82b, the support shafts 32a protrude slightly from the outer surfaces of the frame 82.

The photosensitive-drum-unit guide mechanism 85 includes first engaging grooves 85a for engaging with the plurality of protruding parts 82a formed on the frame 82, and second engaging grooves 85b for engaging with the support shafts 32a of the photosensitive drums 32.

The second engaging grooves 85b are provided with: engaging parts (indentations) 85c (85cM, 85cC, 85cY, and 85cBk) for engaging with the support shafts 32a of the photosensitive drums 32 (32M, 32C, 32Y, and 32Bk), respectively; and urging members (plate spring, for example) 85d (85dM, 85dC, 85dY, and 85dBk) for urging the support shafts 32a of the photosensitive drums 32 (32M, 32C, 32Y, and 32Bk) into the respective engaging parts 85c (85cM, 85cC, 85cY, and 85cBk) and for restricting the support shafts 32a from moving out therefrom.

The bottom of the second engaging grooves 85b are formed at a slant at slanted areas 85e (85eM, 85eC, 85eY, and 85eBk) near the engaging parts 85c (85cM, 85cC, 85cY, and 85cBk).

When mounting the photosensitive drum unit 81 into the body of the printer 10, the photosensitive drum unit 81 is inserted into the photosensitive-drum-unit guide mechanism 85 along the first engaging grooves 85a and second engaging grooves 85b and is fixed in position with the support shafts 32a of the photosensitive drums 32 contacting the engaging parts 85c. As a result, the photosensitive drums 32 are brought into contact with the intermediate transfer belt 58 as shown in FIG. 2. Thus, the support shafts 32a of the photosensitive drums 32 are properly positioned in the main body of the printer 10. The support shafts 32a extend horizontally in the widthwise (right-to-left) direction that is orthogonal to the forward direction, that is, the removal directions of the developing unit 11 and the photosensitive drum unit 81.

When removing the photosensitive drum unit 81 from the body of the printer 10, the pulling action applies a force opposing the urging force of the urging members 85d, so that the support shafts 32a separate from the engaging parts 85c and are pulled out along the second engaging grooves 85b. As a result, the frame 82 moves slightly downwardly and forwardly along the slanted areas 85e of the bottom surface of the second engaging grooves 85b, and the photosensitive drums 32 are brought out of contact with the intermediate transfer belt 58 as shown in FIG. 4.

More specifically, as shown in FIG. 5(b), the frame 82 has a right-side wall 82R, a left-side wall 82L, a front-side wall 82F, and a rear-side wall 82B. The insertion through-holes 82b are formed through each of the right-side wall 82R and the left-side wall 82L.

A pair of caps 32b are fitted to a pair of opposite axial ends (right-side and left-side axial ends) of each tube-shaped photosensitive drum 32. A drum gear 43 (43M, 43C, 43Y, or 43Bk) is attached to one axial end (right-side axial end) of each photosensitive drum 32 (32M, 32C, 32Y, or 32Bk). Each drum gear 43 is fixedly secured to the corresponding photosensitive drum 32, and is incapable of rotating relative to the photosensitive drum 32. In other words, each photosensitive drum 32 rotates together with the corresponding drum gear 43.

The rotational shaft 32a is provided to extend along the central axis of each photosensitive drum 32. The rotational shaft 32a extends rightwardly to pass through the cap 32b and the drum gear 43 at the right-side end of the photosensitive drum 32, and extends leftwardly to pass through the other cap 32b at the left-side end of the photosensitive drum 32. Thus, the rotational shaft 32a protrudes axially outwardly of the photosensitive drum 32 in the widthwise (right-to-left) direction. The photosensitive drum 32 is capable of rotating relative to the rotational shaft 32a.

Each photosensitive drum 32 is supported on the frame 82, with its rotational shaft 32a being inserted through the corresponding insertion through-hole 82b. As shown in FIG. 5(b), the support shafts 32a are inserted through the insertion through-holes 82b and protrude outwardly from the frame 82 in the widthwise direction, that is, protrude rightwardly from the right-side wall 82R and leftwardly from the left-side wall 82L. The protruding amounts of the support shafts 32a are different from one another. That is, the protruding amount of the support shaft 32a in the photosensitive drum 32Bk is the smallest, the protruding amount of the support shaft 32a in the photosensitive drums 32Y is the second smallest, the protruding amount of the support shaft 32a in the photosensitive drums 32C is the third smallest, and the protruding amount of the support shaft 32a in the photosensitive drums 32M is the largest.

The photosensitive-drum-unit guide mechanism 85 has a pair of guide walls (right-side guide wall 85R and a left-side guide wall 85L) that are distant from each other in the widthwise (right-to-left) direction. Each guide wall 85R, 85L includes the first engaging groove 85a (FIG. 5(a)) and the second engaging groove 85b. As shown in FIG. 5(b), the photosensitive drum unit 81 is mounted in the space between the pair of guide walls 85L and 85R, with the right-side wall 82R confronting the right-side guide wall 85R and the left-side wall 82L confronting the left-side guide wall 85L.

Each second engaging groove 85b has: a black-groove part 85bBk for receiving the protruding support shaft 32a of the black photosensitive drum 32Bk; a yellow-groove part 85bY for receiving the protruding support shaft 32a of the yellow photosensitive drum 32Y; a cyan-groove part 85bC for receiving the protruding support shaft 32a of the cyan photosensitive drum 32C; and a magenta-groove part 85bM for receiving the protruding support shaft 32a of the magenta photosensitive drum 32M.

The black-groove part 85bBk, yellow-groove part 85bY, cyan-groove part 85bC, and magenta-groove part 85bM are located as being shifted from one another in the widthwise (right-to-left) direction. That is, the black-groove part 85bBk is on the innermost side, the yellow-groove part 85bY is on the second innermost side, the cyan-groove part 85bC is on the third innermost side, and the magenta-groove part 85bM is on the outermost side.

In each guide wall 85R, 85L, the black-groove part 85bBk, yellow-groove part 85bY, cyan-groove part 85bC, and magenta-groove part 85bM extend rearwardly from the front end (not shown) of the guide wall 85R, 85L by the lengths that are different from one another. That is, the black-groove part 85bBk extends the farthest, the yellow-groove part 85bY extends the second farthest, the cyan-groove part 85bC extends the third farthest, and the magenta-groove part 85bM extends the shortest.

As shown in FIGS. 5(b) and 5(c), each guide wall 85R, 85L has: a black end wall 85fBk at the farthest end of the black-groove part 85bBk; an yellow end wall 85fY at the farthest end of the yellow-groove part 85bY; a cyan end wall 85fC at the farthest end of the cyan-groove part 85bC; and a magenta end wall 85fY at the farthest end of the magenta-groove part 85bM.

As shown in FIG. 5(a) and FIG. 5(c), each guide wall 85R, 85L has: the black engaging part 85cBk on the top of the black-groove part 85bBk near the black end wall 85fBk; the yellow engaging part 85cY on the top of the yellow-groove part 85bY near the yellow end wall 85fY; the cyan engaging part 85cC on the top of the cyan-groove part 85bC near the cyan end wall 85fC; and the magenta engaging part 85cM on the top of the magenta-groove part 85bM near the magenta end wall 85fM. The support shaft 32a of each photosensitive drum 32 (32Bk, 32Y, 32C, or 32M) is engaged in the corresponding engaging part 85c (85cBk, 85cY, 85cC, or 85cM).

As shown in FIG. 5(b) and FIG. 5(c), each guide wall 85R, 85L has: the black slanted area 85eBk on the bottom of the black-groove part 85bBk near the black end wall 85fBk; the yellow slanted area 85eY on the bottom of the yellow-groove part 85bY near the yellow end wall 85fY; the cyan slanted area 85eC on the bottom of the cyan-groove part 85bC near the cyan end wall 85fC; and the magenta slanted area 85eM on the bottom of the magenta-groove part 85bM near the magenta end wall 85fM. In other words, the bottom surface of each groove part 85bBk, 85bY, 85bC, or 85bM gradually rises at the corresponding slanted area 85eBk, 85eY, 85eC, or 85eM to reach the corresponding end wall 85fBk, 85fY, 85fC, or 85fM.

As shown in FIG. 5(b) and FIG. 5(c), each guide wall 85R, 85L has: the black urging member 85dBk on the bottom of the black-groove part 85bBk at the black slanted area 85eBk; the yellow urging member 85dY on the bottom of the yellow-groove part 85bY at the yellow slanted area 85eY; the cyan urging member 85dC on the bottom of the cyan-groove part 85bC at the cyan slanted area 85eC; and the magenta urging member 85dM on the bottom of the magenta-groove part 85bM at the magenta slanted area 85eM. Each urging member 85d is a plate spring, in this example, for urging the support shaft 32a of the corresponding photosensitive drum 32 into the corresponding engaging part 85c and for restricting the support shaft 32a from moving out therefrom. Accordingly, both of the right-side and left-side ends (longitudinal ends) of the rotational shafts 32 that protrude out of the frame 82 are held in the engaging parts 85c by the urging members 85d on both of the right-side and left-side guide walls 85R and 85L in the main body (photosensitive-drum-unit-guide mechanism 85) of the printer 10.

As shown in FIG. 5(d), two female coupling members 41 are provided on the right-side wall 82R. Each female coupling member 41 is provided on the inner side of the frame 82, that is, on the left side of the right-side wall 82R. Each female coupling member 41 is rotatable about its rotational axis that extends in the widthwise (right-to-left) direction. Each female coupling member 41 has a receiving bore 41a that extends along the rotational axis of the female coupling member 41 and that is opened on the right-side axial end of the female coupling member 41. The open end of the receiving bore 41a is exposed outside of the frame 82 (right side of the right-side wall 82R) via a through-hole (not shown) that is formed through the right-side wall 82R. An outer gear 41b is formed on the outer periphery of a part of the female coupling member 41 that is on the inner side of the frame 82 (left side of the right-side wall 82R).

As shown in FIG. 5(c), two male coupling members 40 are provided on the right-side guide wall 85R. Each male coupling member 40 is rotatable about its rotational axis that extends in the widthwise (right-to-left) direction. Although not shown, a motor is provided in the body of the printer 10 on the outer side of the photosensitive-drum-unit guide mechanism 85, that is, on the right side of the right-side guide wall 85R. The male coupling members 40 are connected to the motor. The coupling members 40 can therefore be driven by the motor to rotate about its rotational axis.

When the photosensitive drum unit 81 is mounted in the photosensitive-drum-unit guide mechanism 85, the male coupling members 40 move to protrude inwardly in the widthwise direction from the photosensitive-drum-unit guide mechanism 85. That is, the male coupling members 40 move to protrude leftwardly from the right-side guide wall 85. The male coupling members 40 are inserted into the receiving bores 41a of the female coupling members 41. As a result, the male coupling members 40 are engaged with the female coupling members 41. It is noted that the male coupling members 40 are retracted from the female coupling members 41, while the photosensitive drum unit 81 is moving relative to the photosensitive-drum-unit guide mechanism 85 so as to be mounted in or removed from the photosensitive-drum-unit guide mechanism 85.

As shown in FIG. 5(b) and FIG. 5(d), the drum gears 43 (43Bk, 43Y, 43C, and 43M), which are provided on the right-side axial ends of the photosensitive drums 32 (32Bk, 32Y, 32C, and 32M), are located on the inside of the frame 82, that is, on the left side of the right-side wall 82R. As shown in FIG. 5(d), four intermediate gears 42 are provided on the inner side of the frame 82, that is, on the left side of the right-side wall 82R. Each intermediate gear 42 is in engagement with the outer gear 41b of one female coupling member 41 and one drum gear 43 that sandwich the subject intermediate gear 42 therebetween. Accordingly, when the photosensitive drum unit 81 is mounted in the photosensitive-drum-unit guide mechanism 85, the power is transmitted from the motor in the body of the printer 10 through the male coupling members 40, the female coupling members 41, the intermediate gears 42, and the drum gears 43 to the photosensitive drums 32. Accordingly, the photosensitive drums 32 can be driven to rotate.

The printer 10 having the construction described above is provided in the body thereof with: the exposing device 35 that forms electrostatic latent images on the surfaces of the photosensitive drums 32; the plurality of developer cartridges 31 that have the developer cases 39 accommodating toner and having openings formed on the top side and that have developing rollers 36 disposed near the openings in the developer cases 39 and developing latent images formed by the exposing device 35 into visible images by supplying toner from the developer cases 39 onto the photosensitive drums 32; and the secondary transfer roller 54 and intermediate transfer rollers 53 for transferring the visible images formed on the photosensitive drums 32 onto a recording medium. The printer 10 also includes the tray 12 that is accommodated at the first accommodating position in the body of the printer 10 independent of the photosensitive drums 32. The tray 12 retains the plurality of the developer cartridges 31 arranged in a row in the removal direction that is orthogonal to the support shafts 32a of the photosensitive drums 32 and is substantially horizontal. The tray 12 can be pulled from the first accommodating position to the first removal position in the substantially horizontal removal direction orthogonal to the support shafts 32a.

This construction maintains the rigidity of the printer 10 and prevents the interior of the printer 10 from being contaminated with toner. The construction also facilitates movement of the tray 12.

The construction also ensures accuracy in positioning the components of the printer 10, and particularly the support shafts 32a for the photosensitive drums 32.

For example, if the printer 10 were configured so that the rollers, such as the photosensitive drums 32 and the developing rollers 36, are withdrawn along the axial direction thereof, it would be difficult to reliably fix the support shafts of the rollers when mounted in the printer 10. The support shafts of the rollers would tend to wobble and to become out of the right positions. However, since the printer 10 is configured so that the rollers 36 are removed as a single unit in a substantially horizontal direction orthogonal to the axial direction of the rollers 36 and the rollers 32 are removed as a single unit in a substantially horizontal direction orthogonal to the axial direction of the rollers 32, it is possible to prevent wobble in the support shafts of the rollers. It is possible to bring the support shafts in the right positions.

Because the photosensitive drums 32 are removed as a single unit in the forward direction that is orthogonal to the axial direction of the photosensitive drums 32 (right-to-left direction), it is unnecessary to form openings in either side (right-side or left-side) of the main body that are located on the longitudinal ends of the support shafts 32a. Accordingly, the main body of the printer 10 can support the support shafts 32a on both longitudinal ends thereof. That is, the photosensitive-drum-unit guide mechanism 85 can support the support shafts 32a at their right and left ends by both of the right-side and left-side guide walls 85R and 85L, respectively. This construction ensures that the support shafts 32a are located in the right positions. While being supported by the right and left side walls 82R and 82L of the frame 82, the photosensitive drums 32 can be easily removed from the printer 10 in the direction that is orthogonal to the axial direction of the support shafts 32a.

The bottom of the second engaging grooves 85b are formed at a slant at the slanted areas 85e (85eM, 85eC, 85eY, and 85eBk) near the engaging parts 85c (85cM, 85cC, 85cY, and 85cBk) so that the photosensitive drums 32 are not damaged by sliding against the intermediate transfer belt 58 when removing the photosensitive drum unit 81. In other words, the second engaging grooves 85b are configured so that the photosensitive drums 32 will not contact the transfer unit 50a (intermediate transfer belt 58) until the support shafts 32a arrive in the engaging parts 85c.

The printer 10 is configured so that the developer cartridges 31 can be pulled out while the photosensitive drums 32 and the exposing device 35 remain in the main body of the printer 10. Accordingly, the weight of the portion being removed can be lessened, preventing the printer 10 from falling over. Further, by reducing the number of components that are removed, the size of the opening in the body of the printer 10 through which the components are removed (the size of the opening formed in the frame of the printer 10 by opening the cover 21) can be reduced, making the printer 10 rigid.

Further, the tray 12 can be moved by the moving mechanism constructed from the linking members 23, lifting support members 24, lifting members 25, and horizontal moving member 26 between the first accommodating position (FIG. 1) and the standby position (FIG. 2) that is located between the first accommodating position and the first removal position (FIG. 3). This construction facilitates movement of the tray 12.

It is noted that an operation for accommodating the tray 12 in the first accommodating position or removing the tray 12 from the first accommodating position requires a relatively large amount of force, in order to fixedly secure the developing unit 11 relative to the main body of the printer 10 and in order to accurately position the developing unit 11 relative to the main body of the printer 10. When moving the tray 12, this operation for accommodating the tray 12 in the first accommodating position or removing the tray 12 from the first accommodating position is performed using the moving mechanism constructed from the linking members 23, lifting support members 24, lifting members 25, and horizontal moving member 26. Accordingly, the printer 10 facilitates movement of the tray 12.

Further, the first accommodating position (FIG. 1) and the standby position (FIG. 2) are separate from each other vertically and are both positioned between the photosensitive drums 32 and the exposing device 35. Hence, when moving the tray 12 from the first accommodating position to the standby position, the tray 12 can easily be moved vertically by using the support base 22, linking members 23, lifting support members 24, lifting members 25, and horizontal moving member 26.

Further, the tray 12 is capable of sliding over the top surface of the support base 22 so that the tray 12 can be moved between the first accommodating position and the first removal position over the top surface of the support base 22. Hence, the tray 12 can be moved along the support base 22, allowing for smooth movement of the tray 12.

The printer 10 includes the door 21 positioned on the path of the tray 12 that moves over the support base 22, and is capable of moving the tray 12 from the first accommodating position (FIG. 1) to the first removal position (FIG. 3) when the door 21 is opened. The printer 10 includes the lifting mechanism 20 that moves the tray 12 from the first accommodating position to the standby position by driving the support base 22 when the door 21 is changed from a closed state to an open state, and moves the tray 12 from the standby position back to the first accommodating position by raising the support base 22 when the door 21 is changed from the open state to the closed state. With this construction, the support base 22 is driven in association with movement of the door 21, thereby efficiently moving the tray 12. Further, the support base 22 is configured so that the tray 12 can be separated from the body of the printer 10 after being moved to the first removal position.

The printer 10 also includes: the frame 82 that retains the photosensitive drums 32 and that is accommodated at the second accommodating position (FIG. 1) in the main body; and the photosensitive-drum-unit guide mechanism 85 for moving the frame 82 between the second accommodating position and the second removal position (FIG. 4) that is separate from the second accommodating position in the removal direction, which is substantially horizontal.

With this construction, both the developer cartridges 31 and the photosensitive drums 32 can be easily removed from the body of the printer 10.

The direction for removing the developing unit 11 and the direction for removing the photosensitive drum unit 81 are the same direction. Since both the tray 12 and the frame 82 can be removed from the printer 10 in the same direction, space need only be allocated on one side of the printer 10 when considering installation locations, facilitating installation of the printer 10.

The tray 12 includes the plurality of partitioning plates 12a and side walls 12d for detachably holding the developer cartridges 31. Each of the developer cartridges 31 has peripheral parts that engage with the partitioning plates 12a and side walls 12d. Hence, the developer cartridges 31 can be mounted in or removed from the tray 12, enabling the developer cartridges 31 to be individually replaced. As a result, the running cost of the printer 10 can be decreased.

Further, the support base 22 is configured so that the tray 12 can be separated from the body of the printer 10 after being moved to the first removal position. Hence, by removing the tray 12 from the printer 10, cleaning or other maintenance can easily be performed on the tray 12 and the interior of the printer 10.

Further, the developer cases 39 have openings formed on the top side for supplying toner externally, and the developing rollers 36 are disposed near the openings of the respective developer cases 39. The tray 12 has a box shape constructed of the bottom wall 12c and the side walls 12d erected on the periphery of the bottom wall 12c. Thus providing the bottom wall 12c on the tray 12 strengthens the tray 12. Further, any toner that may spill from the developer cartridges 31 is collected on the bottom wall 12c, thereby preventing toner from contaminating the interior of the printer 10.

The developing rollers 36 have support shafts 36a for positioning, and the side walls 12d of the tray 12 include cutout parts 12e that engage with these support shafts 36a. Hence, by disposing the developing rollers 36 near the top edge of the tray 12, the cutout part 12e retaining the support shafts 36a can be made shallower, thereby preventing a decline in the strength of the tray 12.

By improving the stiffness of the printer 10, as described above, it is possible to restrain vibrations during image formation. Accordingly, the construction described above prevents toner from falling into the interior of the printer 10 due to such vibrations.

The developer is transferred upward from the developing unit 11 onto the intermediate transfer belt 58, and then is transferred from the intermediate transfer belt 58 to the recording medium. The recording medium is prevented from falling. The developer transferred onto the intermediate transfer belt 58 is prevented from falling into the printer 10.

In the printer 10, each of the developing unit 11 and the photosensitive drum unit 81 can be removed from the printer 10 after being withdrawn to the prescribed position (first and second removal position). However, the units may be configured more like a desk drawer. In other words, an engaging part can be provided for temporarily stopping the unit when the unit is withdrawn to the prescribed position (first removal position). From this position, the front of the unit is lifted upward, allowing the unit to pass over the engaging part so that the unit can be removed from the body of the printer 10.

Further, in the printer 10, a visible image is temporarily transferred from the photosensitive drums 32 onto the intermediate transfer belt 58 and subsequently transferred from the intermediate transfer belt 58 to a recording medium. However, the visible image may instead be transferred directly from the photosensitive drums 32 onto the recording medium.

Further, the support base 22 is configured so that the tray 12 can be separated from the body of the printer 10 after being moved to the first removal position. However, the support base 22 may instead be configured to support the tray 12 without allowing the tray 12 to be separated from the body of the printer 10.

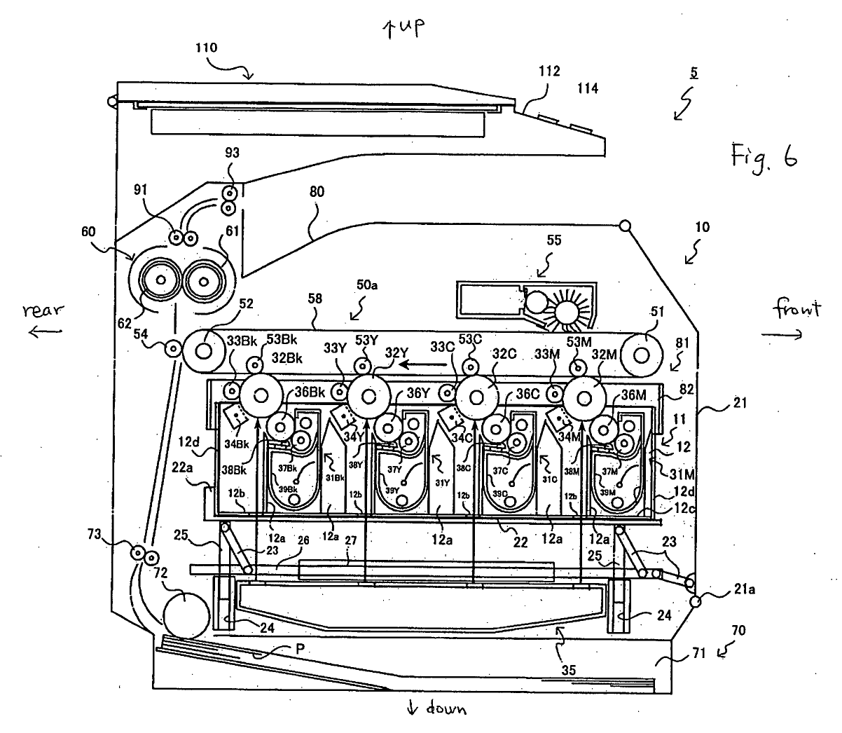

Further, the printer 10 is provided only with an image-forming function, but may be configured as a multifunction device 5, such as that shown in FIG. 6. In addition to the printer 10, this multifunction device 5 is provided with a scanner 110 disposed above the printer 10.

The multifunction device 5 reads images from a document with the scanner 110, the exposing device 35 forms electrostatic latent images on the photosensitive drums 32 based on the image data generated by the scanner 110, the developing unit 11 develops the electrostatic latent images into visible images, and the transfer unit 50a transfers the visible images onto a recording medium.

As shown in FIG. 6, the discharge tray 80 of the multifunction device 5 is disposed between the scanner 110 and the printer 10. Since the multifunction device 5 has a low center of gravity with the developer cartridges 31 arranged horizontally, the printer 10 remains stable even when providing the scanner 110 above the printer 10. Since the multifunction device 5 must have high rigidity when providing the scanner 110 on the top in this way, the structure described above for improving the rigidity of the printer 10 can maintain the overall rigidity of the multifunction device 5 when the scanner 110 is disposed on the top in this way. Further, by positioning the scanner 110 on the top, neither the tray 12 nor the photosensitive drum unit 81 conflicts with the scanner 110 when removed from the printer 10. In other words, since the scanner 110 does not interfere with the removal of the tray 12 or the photosensitive drum unit 81, there is no need to move the scanner 110 in order to remove the tray 12 or the photosensitive drum unit 81.

Further, since the discharge tray 80 is disposed between the body of the printer 10 and the scanner 110, the overall height of the multifunction device 5 can be lower than when the discharge tray 80 is provided above the scanner 110. Further, since the discharge tray 80 does not protrude from the device, the amount of space occupied by the device can be reduced.

Further, a control panel 112 can be disposed near the scanner 110 and may be provided with operating parts 114 that can be operated by the user. The multifunction device 5 configured in this way is more user-friendly than a conceivable device that provides the control panel 112 on the outer wall of the printer 10.

While the invention has been described in detail with reference to the above-described aspects thereof, it would be apparent to those skilled in the art that various changes and modifications may be made therein without departing from the spirit of the invention.

In each of the above-described printer 10 and multifunction device 5, the plurality of photosensitive drums 32 are provided in one to one correspondence with the plurality of developer cartridges 31, that is, in one to one correspondence with the plurality of different colors. However, only a single photosensitive drum 32 may be provided for all the plurality of developer cartridges 31, that is, for all the plurality of different colors. In this case, the exposing device 35 forms a plurality of electrostatic latent images for the plurality of colors on the single photosensitive drum 32 at different locations or at different timings. Each developer cartridge 31 develops a corresponding electrostatic latent image formed on the photosensitive member into a visible image of a corresponding color. The transfer unit 50a transfers the visible images formed on the single photosensitive member to a recording medium. Or, two or more photosensitive drums 32, whose number is smaller than the number of the developer cartridges 31, may be provided. Each photosensitive drum 32 may be used for forming one or two electrostatic latent images to be developed by corresponding one or two developing cartridges 31.

A photosensitive member other than the photosensitive drum, such as a photosensitive belt, for example, may be used instead of the photosensitive drum.

What is claimed is:

1. An image-forming apparatus, comprising:
a main body;
at least one photosensitive member, the photosensitive member having an axis;
an exposing unit that forms electrostatic latent images on the surface of the photosensitive member;
a plurality of developing units, each developing unit having a developer-accommodating section that accommodates developer and a developer-carrying member that develops a corresponding electrostatic latent image formed by the exposing unit on the photosensitive member into a visible image by supplying developer from the developer-accommodating section onto the surface of the photosensitive member;
a transferring unit that transfers the visible images formed on the photosensitive member to a recording medium; and
a first holding unit that holds the plurality of developing units that are arranged in a row along a first removal direction that is orthogonal to the axis of the photosensitive member and that is substantially horizontal, the first holding unit being accommodated at a first accommodating position in the main body and being capable of being moved, independently from the photosensitive member, to a first removal position that is separate from the first accommodating position in the first removal direction.

2. An image-forming apparatus according to claim 1, wherein the first holding unit is capable of moving from the first accommodating position to the first removal position through a standby position, the standby position is defined at a location between the first accommodating position and the first removal position and is separate from the first accommodating position in a vertical direction; and
the first accommodating position and the standby position are located between the photosensitive member and the exposing unit.

3. An image-forming apparatus according to claim 2, further comprising a moving unit that moves the first holding unit between the first accommodating position and the standby position.

4. An image-forming apparatus according to claim 3, further comprising:
a first guiding unit providing a path along which the first holding unit moves;
a door positioned along the path of the first holding unit and enabling the first holding unit to move from the first accommodating position to the first removal position when opened; and
a linking unit that links the door to the moving unit, the linking unit controlling the moving unit to move the first holding unit from the first accommodating position to the standby position when the door is opened, the linking unit controlling the moving unit to move the first holding unit from the standby position to the first accommodating position when the door is closed.

5. An image-forming apparatus according to claim 4, wherein the first guiding unit enables the first holding unit to move between the standby position and the first removal position.

6. An image-forming apparatus according to claim 5, wherein the first guiding unit enables the first holding unit to be separated from the main body when the first holding unit is moved to the first removal position.

7. An image-forming apparatus according to claim 1, further comprising:
a second holding unit that holds the photosensitive member and that is accommodated at a second accommodating position in the main body; and
a second guiding unit that enables the second holding unit to move between the second accommodating position and a second removal position that is separate from the second accommodating position in a second removal direction that is substantially horizontal.

8. An image-forming apparatus according to claim 7, wherein the first removal direction and the second removal direction are substantially identical.

9. An image-forming apparatus according to claim 7, wherein the main body includes:
a pair of opposite walls that are distant from each other in a direction in which the axis of the photosensitive member extends, the pair of opposite walls having a pair of engaging portions; and
a pair of urging members that are provided on the pair of opposite walls and that urge both of longitudinal ends of the axis of the photosensitive member to the pair of engaging portions when the second holding unit is in the second accommodating position.

10. An image-forming apparatus according to claim 1, further comprising an image-reading unit that is disposed above the main body, that reads an image formed on a document, and that generates image data based on the image;
wherein the exposing unit forms the electrostatic latent images on the photosensitive member based on the image data generated by the image-reading unit.

11. An image-forming apparatus according to claim 10, further comprising a recording medium accommodating section that is disposed between the main body and the image-reading unit and that accommodates the recording medium that has been formed with the visible images thereon.

12. An image-forming apparatus according to claim 1, wherein the developer-accommodating section has an opening formed in the top thereof and supplies developer accommodated in the developer-accommodating section externally through the opening;
the developer-carrying member is disposed near the opening; and
the first holding unit has a box shape having a bottom wall and a side wall extending from a periphery of the bottom wall.

13. An image-forming apparatus according to claim 12, wherein each developer-carrying member comprises a protruding part; and
the side wall of the first holding unit has cutout parts, with which the protruding parts of the developer-carrying member are engaged.

14. An image-forming apparatus according to claim 1, wherein the at least one photosensitive member includes a plurality of photosensitive members in one to one correspondence with the plurality of developing units, each photosensitive member having an axis;
wherein the exposing unit forms electrostatic latent images on the surfaces of the photosensitive members;
wherein the developer-carrying member of each developing unit develops the electrostatic latent image formed by the exposing unit on a corresponding photosensitive member into a visible image by supplying developer from the developer-accommodating section onto the surface of the photosensitive member;
wherein the transferring unit transfers the visible images formed on the photosensitive members to a recording medium;
wherein the first removal direction is orthogonal to the axes of the photosensitive members; and
wherein the first holding unit is capable of being moved, independently from the photosensitive members, to the first removal position.
